(19) United States
(12) Patent Application Publication
(10) Pub. No.: US 2021/0249824 A1
(43) Pub. Date: Aug. 12, 2021

(54) PORTABLE POWER OUTLET AND SYSTEM FOR REMOTE CHARGING

(71) Applicant: CARL SPARROW, BEAUMONT, TX (US)

(72) Inventor: CARL SPARROW, BEAUMONT, TX (US)

(21) Appl. No.: 17/172,052

(22) Filed: Feb. 9, 2021

Related U.S. Application Data
(60) Provisional application No. 62/972,605, filed on Feb. 10, 2020.

(51) Int. Cl. H01R 13/66; H02J 7/00; H02J 7/02; H02J 50/12; H02J 50/50; H01R 13/717; H01R 25/00

(52) U.S. Cl. CPC H01R 13/6675; H02J 7/0042; H02J 7/02; H01R 25/006; H02J 50/50; H01R 13/7175; H02J 50/12

(57) ABSTRACT

A portable outlet system and method for providing electrical power transmitted from an electrical outlet wirelessly to the portable outlet system for supply to one or more electrical devices connected to the portable outlet system through one or more standard electrical device connectors. The portable outlet system is rechargeable and can optionally include LED lights as well as a handle to facilitate portability. The portable outlet system may include monitors, data receivers and transmitters, and power boosters or relays. The portable outlet system has actuators for power and LED lights and may include an actuator for device synchronizations.

### CLAIM OF PRIORITY

This application claims priority to and the benefit of U.S. Provisional Application with Ser. No. 62/972,605, filed on Feb. 10, 2020, titled PORTABLE POWER OUTLET, which is herein incorporated by reference in its entirety.

### FIELD OF THE INVENTION

The inventive concept relates generally to a portable power outlet.

### BACKGROUND

Currently, there are many solutions for portable power sources. One of these solutions attempts to utilize generators, but this solution fails to meet the needs of the market because generators are often heavy to carry around. Another solution attempts to utilize portable battery packs, but this solution is similarly unable to meet the needs of the market because battery packs may be heavy and run out of charge when the batteries are depleted. Still another solution seeks to utilize solar-powered battery packs, but this solution also fails to meet market needs because there may be limited sunlight to charge the batteries. Yet another solution connects an electrical device to an electrical outlet using a power cord, but this solution can be cumbersome when the electrical device is not collocated with the electrical outlet. Therefore, there is a need in the market for an apparatus that charges electronic devices without the drawbacks associated with the existing solutions.

### SUMMARY OF THE INVENTION

The inventive concept provides electrical power remotely from an electrical outlet. The inventive concept includes a housing assembly with at least one surface of the housing assembly having at least one electrical connector input designed to provide power to one or more electrical devices. The housing assembly includes one or more circuit modules coupled to at least one wireless RF (radio frequency) power receiver, wherein the one or more circuit modules is operatively coupled to at least the first electrical connector. At least one power transmitter module is designed to transfer power wirelessly to the one or more power receiver circuit modules in which the at least one power transmitter is adapted to connect with and receive power from an electrical outlet.

The housing assembly may have one or more connectors that represent any one or more of the standard electrical outlets used in the United States or internationally, such as an RS2. The housing assembly may also or exclusively include at least one connector that is a universal serial bus, often called a USB port. LED lights may illuminate at least one surface of the housing assembly and in a related embodiment may be dimmable to various levels of intensity depending on a user's needs. The inventive concept may incorporate a reset button for at least one wireless power transmitter assembly. One or more circuit modules on or within the inventive concept may be connected to a rechargeable battery either or both attached to the housing assembly or disposed within the housing assembly.

The housing assembly in one embodiment has at least one surface of the housing assembly having two RS2 electrical connector inputs and two USB electrical connector inputs designed for providing power to one or more electrical devices, the housing assembly including one or more circuit modules coupled to at least one wireless power receiver, wherein the one or more circuit modules is operatively coupled to at least the first electrical connector. At least one power transmitter module is designed to transfer power wirelessly to the one or more power receiver circuit modules, wherein the at least one power transmitter module is designed to connect with and receive power from one or more electrical outlets. At least one LED is disposed on an outer surface of the housing assembly substantially circumscribing the RS2 and USB electrical connector inputs. This embodiment includes a power actuator, an LED actuator, and a wireless synchronization actuator. This embodiment may include a at least one handle portion coupled to a top portion of the housing assembly.

One skilled in the art would also recognize that the system for providing electrical power disclosed herein may include elements that provide further utility. The system may leverage repeaters or boosters between the system for providing electrical power and the electrical outlet providing wireless power to improve energy flow. The system for providing electrical power itself may also serve as a repeater or booster for one or more comparable devices. The energy flow could come from more than one electrical outlet simultaneously or over separated periods. The system may include sensors or monitors that measure the flow of electric current or the level of charge of one or more rechargeable batteries on or within the system for providing electrical power, so the wireless transmitter only transmits electricity when useful. The system would have utility if it provides power wirelessly to one or more electrical devices to keep those electrical devices operating for as long as the system is operating. The system would also have utility if the system accumulated power wirelessly such that it could provide power to one or more electrical devices for longer than it otherwise could without receiving power wirelessly from one or more electrical outlets. Any surface on the device might be employed to hold the system for providing electrical power. The system for providing electrical power could be dynamic such that by adjustment or by adding an assisting element, the system for providing electrical power could be designed to serve the system for providing electrical power on many types of electrical devices from many different standards and many different voltages. Sensors or monitors may be added along the system to measure the charge and electrical flow. Sensors or monitors may provide data from which to improve performance or controllability.

One embodiment of the system for providing electrical power collects and transmits data measuring the performance of the system for providing electrical power. Another embodiment of the system for providing electrical power includes electricity sensor assemblies disposed on the housing assembly designed to detect wireless electricity flow. Another embodiment of the system for providing electrical power includes at least one or more of a repeater assembly and a booster assembly disposed between the at least one wireless power transmitter assembly and the system for providing electrical power.

One skilled in the art would recognize that the wireless transmitter may be coupled to a power source directly without requiring a standard electrical outlet, such as by a hardwire direct connection.

The inventive concept now will be described more fully hereinafter with reference to the accompanying drawings, which are intended to be read in conjunction with both this summary, the detailed description and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates the perspective view of a remote electrical power sourcing.

FIG. 2 illustrates the front of the remote power sourcing.

FIG. 3 illustrates the side view of the remote power sourcing.

FIG. 4 illustrates the top view of the remote power sourcing.

FIG. 5 illustrates the rear of a wireless RF power transmitter module.

FIG. 6 illustrates the perspective view of the power transmitter module.

FIG. 7 illustrates the front view of the wireless RF power transmitter module.

FIG. 8 illustrates the side view of the wireless RF power transmitter module.

FIG. 9 illustrates the top view of the wireless RF power transmitter module.

FIG. 10 illustrates a method for using the remote power sourcing RF power transmitter module.

### DETAILED DESCRIPTION OF THE INVENTION

Following are more detailed descriptions of various concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

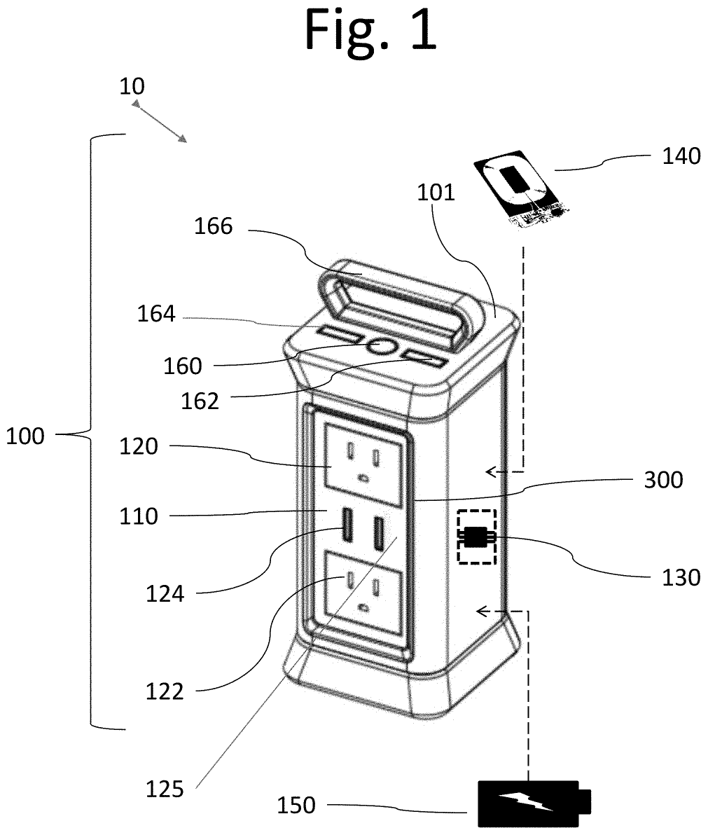

Referring to the Figures, FIGS. 1-4 illustrate part of a remote electrical power sourcing system 10 which includes the housing assembly 100 with at least one surface of the housing assembly 110 having at least one electrical connector input 120 designed for providing AC power to one or more electrical devices. The housing assembly 100 includes one or more control circuit modules 130 coupled to at least one wireless power receiver 140, wherein the circuit module 130 is operatively and electrically coupled to the first electrical connector 120 while in an active mode or coupled to a battery 150 while in a passive mode option. While in the passive mode option, the control circuit module 130 and the power receiver module 140 charge up battery 150 to provide actual or back up power to either connectors 124 or 125. Battery 150 can also provide back up AC power to outlets 120 and 122 where battery 150 is electrically coupled to a DC-AC circuit to then provide AC power to a device that is plugged into outlets 120 and 122. In one example embodiment, wireless power receiver 140 includes a resonator and/or antenna responsive to an electromagnetic wave sent from a corresponding source power transmitter (to be discuss later). For additional teachings on wireless charging and remote far-field power transfer, reference is made to U.S. Pat. Nos. 10,340,745; 9,711,978; 10,608,459; 10,050,436; 10,615,628 and 10,341,367.

In an active mode, wireless power receiver 140 and control circuit module 130 are electrically coupled to outlets 124 and 125 to actively provide DC power as needed for smaller electronic devices using less power. In a related embodiment, wireless power receiver 140 and control circuit module 130 are electrically coupled to outlets 124 and 125 to actively provide DC power to an AC converter circuit (not shown) which is electrically coupled to outlets 120 and 122 to provide continuous AC current to devices that are plugged in. For additional teachings on wireless power transfer and charging, reference is made to U.S. Pat. Nos. 10,340,745; 9,711,978; 10,608,459; 10,050,436; 10,615,628 and 10,341,367.

In this example of embodiment of remote power unit 10 there is provided a power actuator 160 (to activate or deactivate device 10), an LED actuator 162 (to turn on/off LED 300 or provide diming to LED 300), and a wireless synchronization actuator 164 for synchronizing with the power source electromagnetic wave transmitter. At least one handle portion 166 in this embodiment is adapted to connect with a top portion of the housing assembly 101 for ease of portability.

In this example embodiment, housing assembly 100 may have one or more electrical connector inputs 120 and 122, which externally appear to similar to standard electrical outlets used in the United States or internationally. The housing assembly may also or exclusively include at least one connector that is a universal serial bus 124 as well as a firewire connector port 125. LED lights 510 may illuminate at least one housing assembly surface 110. The inventive concept may incorporate a reset button 540 for at least one wireless RF power transmitter module 500. One or more circuit modules 130 on or within the housing assembly 100 may be connected to a rechargeable battery member 150 attached to or within the housing assembly. The aforementioned example embodiments are modifiable to accommodate international power and electrical requirements for power conversion and for RF wave transmission.

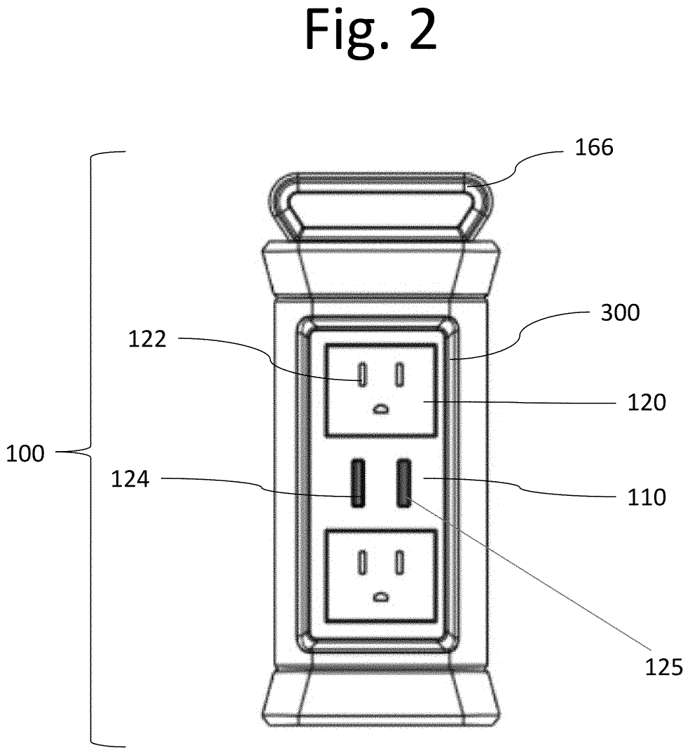

FIG. 2 illustrates the housing assembly 100 front view including an LED lighting element 300, which in this example embodiment is dimmable for uses from a nightlight or to illuminate a short path for the user.

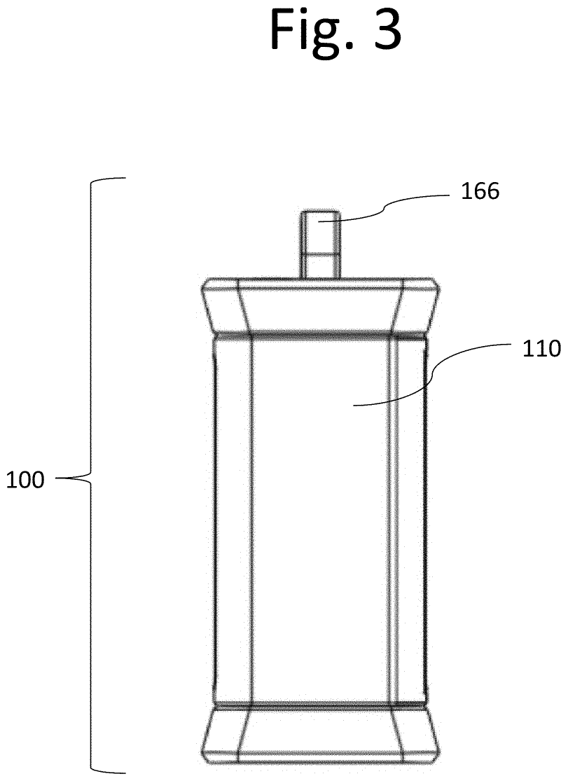

FIG. 3 illustrates the lateral side view of the housing assembly 100.

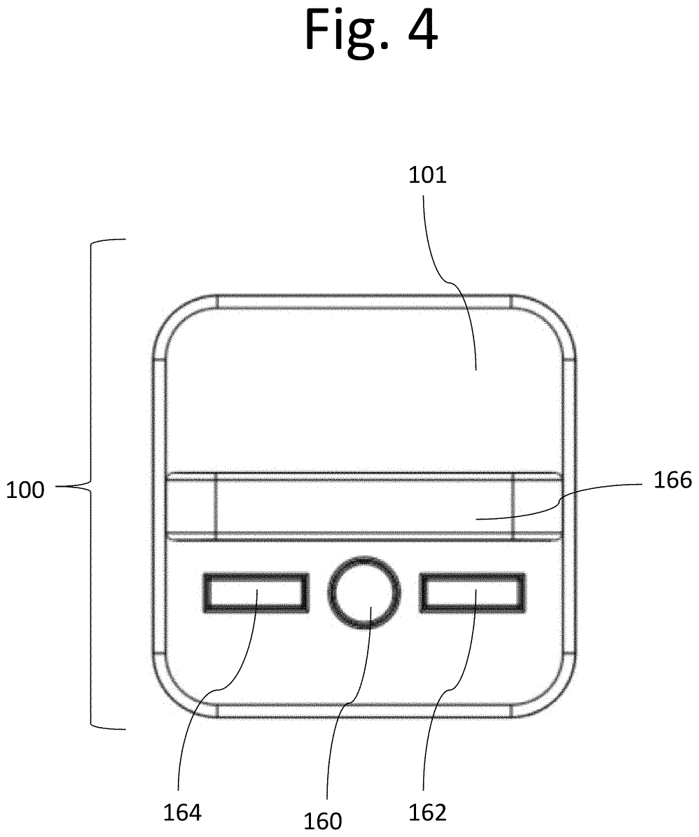

FIG. 4 illustrates the top view of the housing assembly 100.

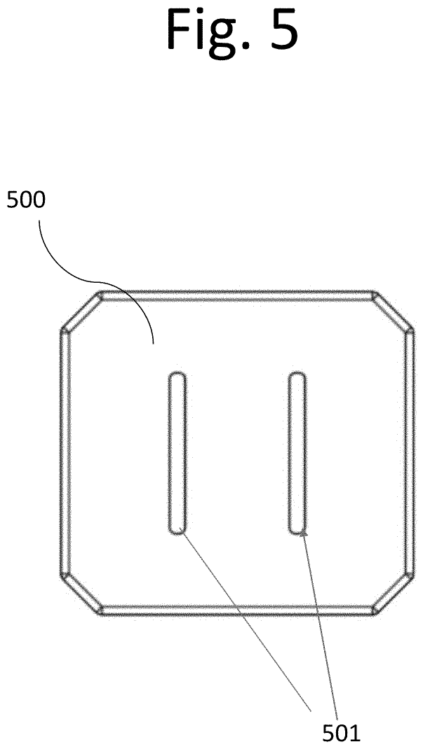

Referring now also to FIGS. 5-9, there is illustrated a wireless RF power transmitter module 500, which forms the other part of the remote power system, that is designed to be plugged into an AC wall outlet providing the source power via prongs 501. FIG. 5 illustrates the rear view of the wireless RF power transmitter module or box 500. In this example embodiment, transmitter module 500 is designed to transfer power wirelessly via electromagnetic waves to, with reference to FIGS. 1 through 4, the one or more wireless power receivers 140, which are housed within housing assembly 100. Power receivers 140 are electrically coupled to the one or more circuit modules 130. In a related embodiment, wireless RF power transmitter module 500 is designed to connect with and receive power from a direct hard wire connection instead of through an existing electrical AC wall outlet. For additional teachings on wireless power transfer and charging, reference is made to U.S. Pat. Nos. 10,340,745; 9,711,978; 10,608,459; 10,050,436; 10,615,628 and 10,341,367.

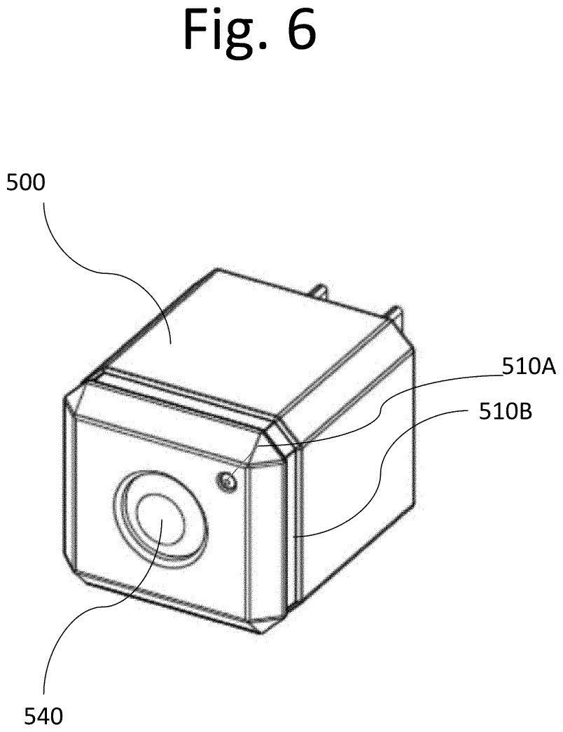

FIG. 6 illustrates the perspective view of the wireless RF power transmitter module or box 500, which includes a reset (or on/off) button 540 and LED lights 510A for operation and 510B for visibility of the unit at night or from a distance.

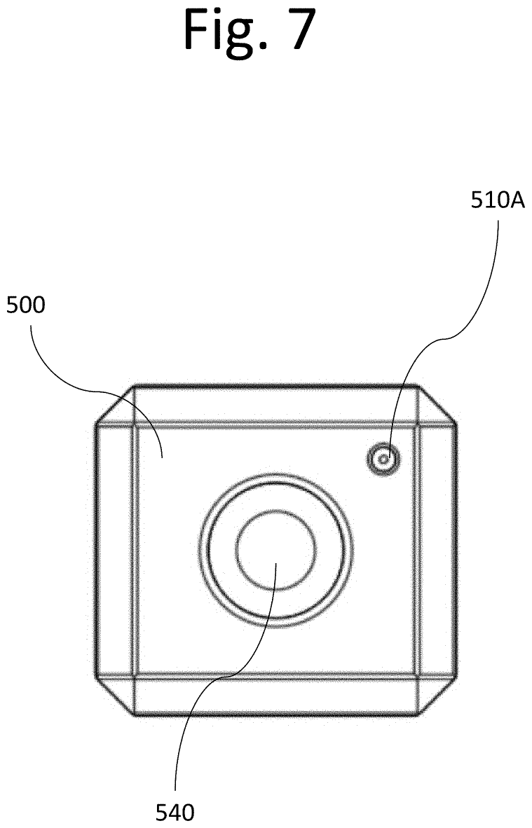

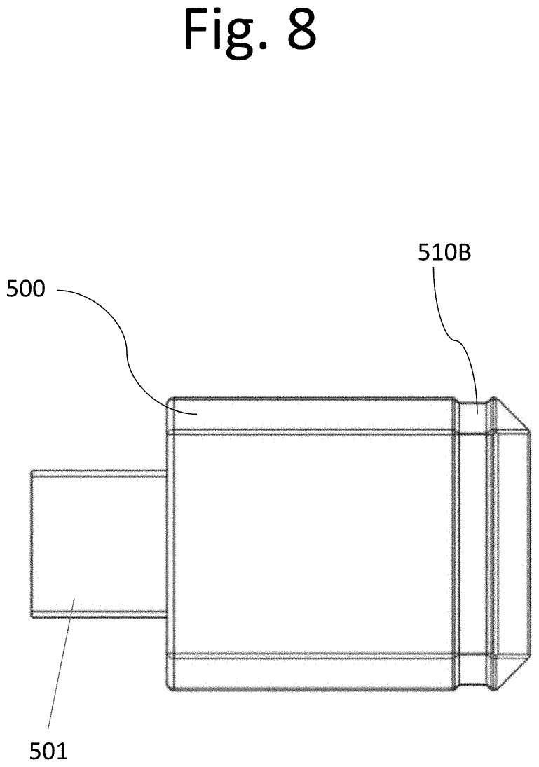

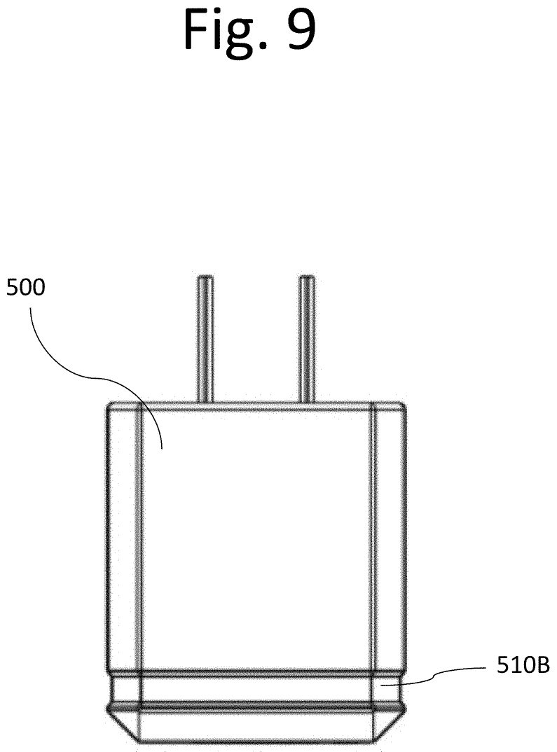

FIG. 7 illustrates the front view of the RF power transmitter module or box 500. FIG. 8 illustrates the lateral side view of the RF power transmitter module or box 500. FIG. 9 illustrates the top side view of the RF power transmitter module or box 500.

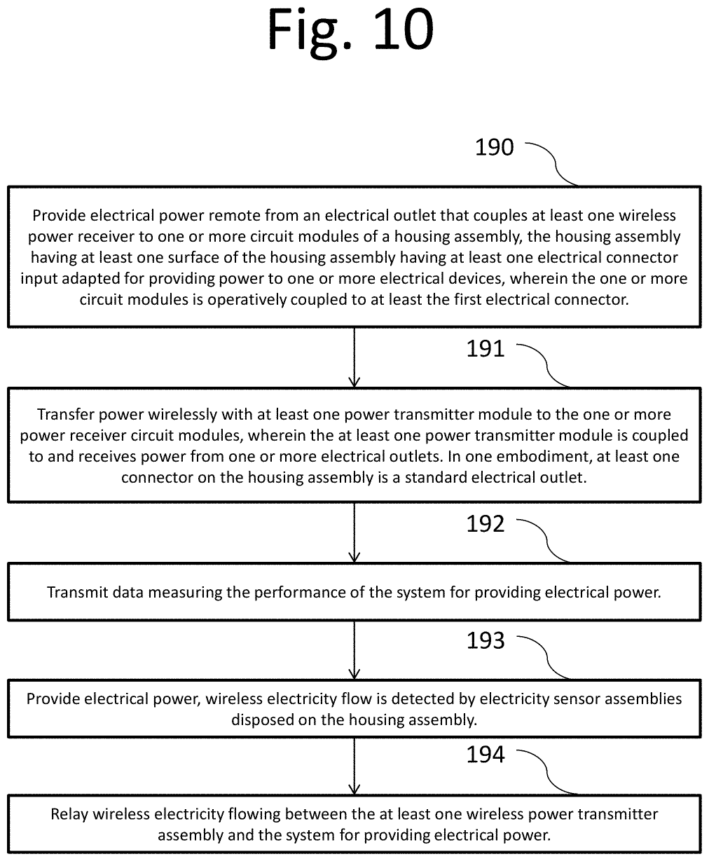

FIG. 10 illustrates one embodiment of a method for providing electrical power remote from an electrical outlet that couples at least one wireless power receiver to one or more circuit modules of a housing assembly, the housing assembly having at least one surface of the housing assembly having at least one electrical connector input designed for providing power to one or more electrical devices, wherein the one or more circuit modules is operatively coupled to at least the first electrical connector 190. Power is transferred wirelessly with at least one power transmitter module to the one or more power receiver circuit modules, wherein the at least one power transmitter module is coupled to and receives power from one or more electrical outlets 191. In one embodiment of the method for providing electrical power, the method includes the step of collecting and transmitting data measuring the performance of the system for providing electrical power 192. In one embodiment of the method for providing electrical power, wireless electricity flow or electromagnetic wave transmission is detected by electricity sensor assemblies disposed on the housing assembly 193. At least one or more of a repeater assembly and a booster assembly may relay wireless electricity flowing between the at least one wireless power transmitter assembly and the system for providing electrical power 194. One of ordinary skill in the art would recognize that other methods may be used that any or all add, abridge, or forgo steps disclosed in this embodiment.

The following patents are incorporated by reference in their entireties: U.S. Pat. Nos. 6,476,311; 5,912,514; 10,193,285; 2011/0101794 and 2018/0109141. For additional teachings on wireless power transfer and charging, reference is made to U.S. Pat. Nos. 10,340,745; 9,711,978; 10,608,459; 10,050,436; 10,615,628 and 10,341,367.

While the inventive concept has been described above in terms of specific embodiments, it is to be understood that the inventive concept is not limited to these disclosed embodiments. Upon reading the teachings of this disclosure many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. A system for providing electrical power from a wireless remote unit from an electrical power outlet or power source remote from the wireless remote unit comprising:
a housing assembly having at least one electrical connector input designed for providing power to one or more electrical devices, the housing assembly including at least one control circuit module electrically coupled to at least one wireless power receiver, wherein an output of the at least one control circuit module is electrically coupled to the at least one electrical connector;
at least one power transmitter module adapted to transmit power wirelessly to the at least one power receiver and control circuit module, wherein the at least one power transmitter module is adapted to connect with and receive power from one of the electrical power outlet or power source; and
at least one LED member electrically connected to the control circuit module and adapted to illuminate on at least one surface of the housing assembly.

2. The system for providing electrical power of claim 1, wherein at least one control circuit module is electrically connected to a DC/AC converter circuit, the DC/AC converter circuit being electrically connected to the at least one electrical outlet on the remote unit to provide AC power as an output.

3. The system for providing electrical power of claim 1, wherein at least one connector disposed on the housing assembly is a universal serial bus or firewire connection which is electrically connected to the at least one control circuit module.

4. The system for providing electrical power of claim 1, wherein at least one control circuit module is electrically connected to a battery member, the battery member being electrically connected to a DC/AC converter circuit, wherein the DC/AC converter circuit is electrically connected to the at least one electrical outlet on the remote unit to provide AC power as an output.

5. The system for providing electrical power of claim 1, wherein the at least one wireless power transmitter assembly incorporates one of a reset or on/off button.

6. The system for providing electrical power of claim 1, wherein the at least one control circuit module is electrically coupled to one or more rechargeable battery members attached to or within the housing assembly.

7. The system for providing electrical power of claim 1, further including a module or sensor adapted to collect and transmit or display data measuring the performance of the system for providing electrical power.

8. The system for providing electrical power of claim 1, wherein electricity sensor assemblies are disposed on the housing assembly adapted to detect wireless power transmission flow or reception.

9. The system for providing electrical power of claim 1, wherein at least one or more of a repeater assembly and a booster assembly are disposed between the at least one wireless power transmitter assembly and the remote power unit.

10. A method for providing electrical power from a wireless remote unit from an electrical outlet or power source that is remote from the wireless remote unit comprising the steps of:
providing at least one wireless power receiver electrically coupled to at least one control circuit module, the power receiver and circuit module providing DC power to one of a DC power outlet on a housing assembly or a DC/AC converter circuit within the housing assembly, wherein the power receiver is adapted to receive electromagnetic energy from the remote power source or electrical outlet;
transmitting power wirelessly with at least one power transmitter module to the one power receiver circuit module and control circuit module, wherein the at least one power transmitter module is adapted to connect with and receive power from the remote power source or electrical outlet; and
providing an LED member on the housing assembly adapted to be electrically connected to the power receiver module and control circuit module combination, wherein the LED member is adapted to illuminate as an indication of power flow being received from the transmitter module.

11. The method for providing electrical power of claim 10, wherein at least one connector on the housing assembly is a standard electrical outlet.

12. The method for providing electrical power of claim 10, wherein at least one connector on the housing assembly is a universal serial bus or a firewire connector.

13. The method for providing electrical power of claim 10, wherein at least one LED illuminates at least one surface of the housing assembly.

14. The method for providing electrical power of claim 10, wherein the at least one wireless power transmitter assembly incorporates a reset or on/off button.

15. The method for providing electrical power of claim 10, wherein the at least one control circuit module is electrically connected to one or more rechargeable battery members attached to or within the housing assembly.

16. The method for providing electrical power of claim 10, further including the step of collecting and transmitting data measuring the performance of the wireless remote unit.

17. The method for providing electrical power of claim 10, further including the step of detecting by electricity sensor assemblies disposed on the housing assembly wireless power flow or electromagnetic waves from the transmitter module.

18. The method for providing electrical power of claim 10, further including the step of providing at least one or more of a repeater assembly and a booster assembly to relay wireless power transmitted between the at least one wireless power transmitter and the remote wireless unit.

19. A system for providing electrical power from a wireless remote unit from an electrical outlet or power source remote from the wireless remote unit comprising:
a housing assembly with at least one surface of the housing assembly having two RS2 electrical connector outputs and two USB electrical connector outputs or ports adapted for providing power to one or more electrical devices, the housing assembly including at least one control circuit module electrically coupled to at least one wireless power receiver, wherein the one control circuit module is electrically connected to at least the electrical and USB connectors;
at least one power transmitter module adapted to transmit power wirelessly to the one power receiver circuit modules, wherein the at least one power transmitter module is adapted to connect with and receive power from a fixed power source;
an DC/AC converter circuit electrically connected to the control circuit module adapted to provide AC power to the RS32 electrical outlet.
at least one LED member disposed on an outer surface of the housing assembly substantially circumscribing the RS2 and USB electrical connector inputs; and
a battery member electrically connected to the control circuit module.

20. A system of claim 19, further including a power actuator and an LED actuator disposed on the housing assembly.
